(19) United States
(12) Patent Application Publication
(10) Pub. No.: US 2014/0102628 A1
(43) Pub. Date: Apr. 17, 2014

(54) METHODS, SYSTEMS, COMPONENTS, AND COMPOSITIONS FOR SIMULTANEOUSLY TREATING A SUBSTRATE AND ADHERING OR APPLYING A BONDING AGENT THERETO

(71) Applicant: GM GLOBAL TECHNOLOGY OPERATIONS LLC, Detroit, MI (US)

(72) Inventors: Hesham A. Ezzat, Troy, MI (US); John C. Ulicny, Oxford, MI (US)

(73) Assignee: GM Global Technology Operations LLC, Detroit, MI (US)

(21) Appl. No.: 13/650,540

(22) Filed: Oct. 12, 2012

(51) Int. Cl. B05D 5/10; B32B 37/12

(52) U.S. Cl. 156/219; 427/207.1; 427/163.1

(57) ABSTRACT

Some select variations may include methods, devices and systems for simultaneously treating a substrate and adhering or applying a bonding agent thereto.

### TECHNICAL FIELD

The field to which this disclosure generally relates includes methods, systems, components and compositions for simultaneously treating a substrate and adhering or applying a bonding agent thereto.

### BACKGROUND

Haack et al, U.S. Patent Application Publication No. 2008/0003634, published Jan. 3, 2008, in the Abstract, states “A method of treating a glass substrate for bonding. The method includes providing a glass substrate having a fritted portion of a ceramic frit material and a non-fritted portion. At least a portion of the fritted portion includes a bondable surface. The method further includes cleaning and activating the bondable surface for subsequent bonding. The cleaning and bonding steps are carried out by applying an air plasma to the bondable surface.”

Gros, U.S. Patent Application Publication No. 2008/0305274, published Dec. 11, 2008, in the Abstract, states “A method for coating sheet metals such as coils with a chromate-free, water-dilutable, organic, UV-curing anti-corrosive coating, and for curing the coating by irradiation with UV light. According to the method a dispersion or emulsion is provided as the UV-curing coating agent for forming the anti-corrosive coating that substantially consists of 25 to 80 wt.-% binder, 1 to 8 wt.-% photoinitiators, 0 to 5 wt. % additive, 20 to 70 wt. % water, and optionally a pigment. The coating agent is applied on the sheet metal, preferably in an inline method, dried to form a film and cured by UV light.”

Straccia et al., U.S. Pat. No. 7,981,219, issued Jul. 19, 2011, in the Abstract, states “A system is provided for plasma treating a plastic component having an exterior surface and an inside surface. The system comprises at least one fixture. The fixture includes a support structure, a plurality of locating features, and a plurality of holding devices which cooperate to position a portion of the exterior surface to within a specified tolerance. The system further comprises at least one APAP nozzle configured to move relative to the exterior surface along a path, wherein the APAP nozzle directs a plasma jet onto the portion producing a functionalized polymer layer covering the portion.”

Eriksson et al., U.S. Pat. No. 7,981,219, issued Jul. 19, 2011, in the Abstract, states “A process for producing a repair coating on at least one metallic surface that is coated with at least one corrosion protecting coating A applied with at least one composition selected from the group of pretreatment compositions, of organic compositions and of silicon compound(s) containing compositions, whereby the at least one corrosion protecting coating A has been at least partially removed in the area Z, whereby a thin corrosion protecting coating B containing at least one silicon compound is applied with a solution or dispersion containing at least one silane, at least one silanol, at least one siloxane, at least one polysiloxane or any mixture of these (=“siloxane composition”) on at least a part of the area Z. Optionally, a further corrosion protecting coating C may be applied on the thin corrosion protecting coating B generated with the siloxane composition whereby the at least one further corrosion protecting coating C is generated with at least one organic composition like a primer, a wet-primer, an e-coat, a powder coat, a base-coat or a clear-coat or with at least one composition which is the same or another siloxane composition as for the thin film B.”

Jackson, U.S. Patent Application Publication No. 2008/0305274, published Dec. 11, 2008, in the Abstract, states “A carbon dioxide snow apparatus of the present invention includes a carbon dioxide snow generation system and a propellant generation system connected to a common carbon dioxide gas source. The carbon dioxide snow generation system includes a condenser having a at least two connected segments, wherein a first segment has a lesser diameter than the a second segment to provide a stepped expansion cavity for cooling and condensing liquid carbon dioxide into solid carbon dioxide snow. Several snow generation systems, each separately controllable with separate condensers, may be integrated with the propellant generation system and common carbon dioxide source to provide for a multiplicity of carbon dioxide snow applicators for integration into both manual and automated machining processes.”

### SUMMARY OF SELECT ILLUSTRATIVE VARIATIONS OF THE INVENTION

Some select variations of the invention may include methods, devices and systems for simultaneously treating a substrate and adhering or applying a bonding agent thereto.

One variation may include a method including simultaneously treating a substrate and adhering or apply a bonding agent thereto including depositing a composition on the substrate including a bonding agent and a surface treatment composition or compound.

In one variation, the substrate comprises a metal having an oxide layer thereon and wherein the surface treatment composition or compound is effective in removing the oxide layer to thereby improve adhesion of the bonding agent to the metal.

One variation may include a process including simultaneously depositing a surface treatment composition or compound on a substrate having an undesirable top layer, and a bonding agent over the surface treatment composition or compound.

Another variation includes a method including simultaneously treating a substrate and adhering or applying a bonding thereto wherein the treating comprises at least one of mechanical removal of an undesirable layer on a substrate or chemical treatment of the undesirable layer.

Another variation may include a method including simultaneously treating a substrate and adhering or applying a bonding agent thereto using a robot having at least one applicator attached to an arm thereof.

Another variation may include a method including simultaneously treating a substrate and adhering or applying a bonding agent thereto including providing at least a bonding agent applicator connected to a rail, and a treatment composition applicator or a mechanical treatment applicator also connected to the rail in a spaced apart relationship, and wherein the chemical treatment applicator or mechanical applicator is advanced along the surface of the substrate ahead of the bonding agent applicator.

Another variation may include a method of simultaneously treating a surface and adhering or applying a bonding agent thereto utilizing remotely controlled carriers having a bonding agent applicator and a chemical treatment applicator and/or mechanical treatment applicator.

Another variation may include a method including simultaneously treating a substrate and adhering or applying a bonding agent thereto wherein the substrate comprises at least one of a front windshield or rear windshield for a vehicle.

Another variation may include a method including providing a sheet of metal comprising aluminum which has not been pretreated to passivate the surface, stamping the sheet comprising aluminum and thereafter simultaneously treating the sheet comprising aluminum to remove any oxide along a portion of the sheet and adhering or applying a bonding agent to the sheet along the portion that has been treated to removed the oxide therefrom.

Another variation may include a method including providing a casting or extrusion comprising aluminum which has not been pretreated to remove an oxide layer thereon and simultaneously treating the casting or extrusion to remove an oxide layer along a portion thereof and adhering or applying a bonding agent to the portion having the oxide layer removed therefrom.

Another variation includes providing a sheet comprising aluminum which has not been pretreated to remove a oxide layer thereof, providing a casting or extrusion comprising aluminum which has not been treated to remove an oxide layer thereof, simultaneously treating the sheet to remove oxide from a portion thereof and adhering or applying a bonding agent to the portion the sheet having the oxide layer removed, and simultaneously treating the casting or extrusion to remove an oxide layer thereon and adhering or applying a bonding agent thereto, and pressing the aluminum sheet and the casting or extrusion together to adhere the same.

Other variations of the invention will become apparent from the detailed description provided hereinafter. It should be understood that the detailed description and specific examples, while disclosing illustrative variations of the invention, are intended for purposes of illustration only and are not intended to limit the scope of the invention.

### BRIEF DESCRIPTION OF THE DRAWINGS

Illustrative variations of the invention will become more fully understood from the following brief description of the drawings.

FIG. 1 illustrates a method and a system for simultaneously treating and adhering or applying a bonding agent to a substrate including depositing a composition including a bonding agent and a chemical composition or compound to treat an undesirable layer on the substrate using a single applicator according to one variation of the invention.

FIG. 2 illustrates a method and a system for simultaneously treating a substrate and adhering or applying a bonding agent thereto, including a single applicator constructed and arranged to simultaneously disperse a composition for treating an undesirable layer on the substrate and for depositing a bonding agent on the substrate according to one variation.

FIG. 3 illustrates a method and a system for simultaneously treating a substrate and adhering or applying a bonding agent thereto, including a device having a mechanical treatment component and/or a chemical composition dispensing component for treating an undesirable layer on a substrate, and for depositing a bonding agent on the substrate according to one variation of the invention.

FIG. 4 illustrates a method and system for simultaneously treating a substrate and adhering or applying the bonding agent thereto, including a robot having at least one applicator thereon for dispensing a chemical composition for treating an undesirable layer on the substrate and for dispensing a bonding agent onto the substrate according to one variation of the invention.

FIG. 5 illustrates a method and system for simultaneously treating a substrate and adhering or applying a bonding agent thereto, including a plurality of applicators spaced apart from each other and connected to a rail for moving the applicators along the surface of a substrate according to one variation of the invention.

FIG. 6 illustrates a method of simultaneously treating a substrate and adhering or applying a bonding agent thereto, including using remotely controlled carriers including applicators for dispensing a bonding agent and applicators for mechanically treating or depositing a chemical composition for treating an undesirable layer on the substrate according to one variation of the invention.

FIG. 7 illustrates two substrates adhered by an adhesive layer applied according to a method including simultaneously treating a substrate and adhering or applying a bonding agent thereto according to one variation of the invention.

FIG. 8 illustrates a product as set forth in FIG. 7 further including a spot weld for connecting two substrates together according to one variation of the invention.

FIG. 9 illustrates a product which may be made according to a method including simultaneously treating a substrate and adhering or applying a bonding agent thereto according to one variation of the invention.

FIG. 10 is a schematic illustration of a process including pretreating aluminum sheets or batch treating aluminum castings or extrusions, and thereafter applying an adhesive to the aluminum sheets or aluminum castings or extrusions.

FIG. 11 illustrates a method including simultaneously treating sheets including aluminum or castings or extrusions including aluminum, and adhering or applying a bonding agent thereto according to one variation of the invention.

### DETAILED DESCRIPTION OF SELECT ILLUSTRATIVE VARIATIONS

The following detailed description of select variations is merely illustrative in nature and is in no way intended to limit the claimed inventions, applications, or uses.

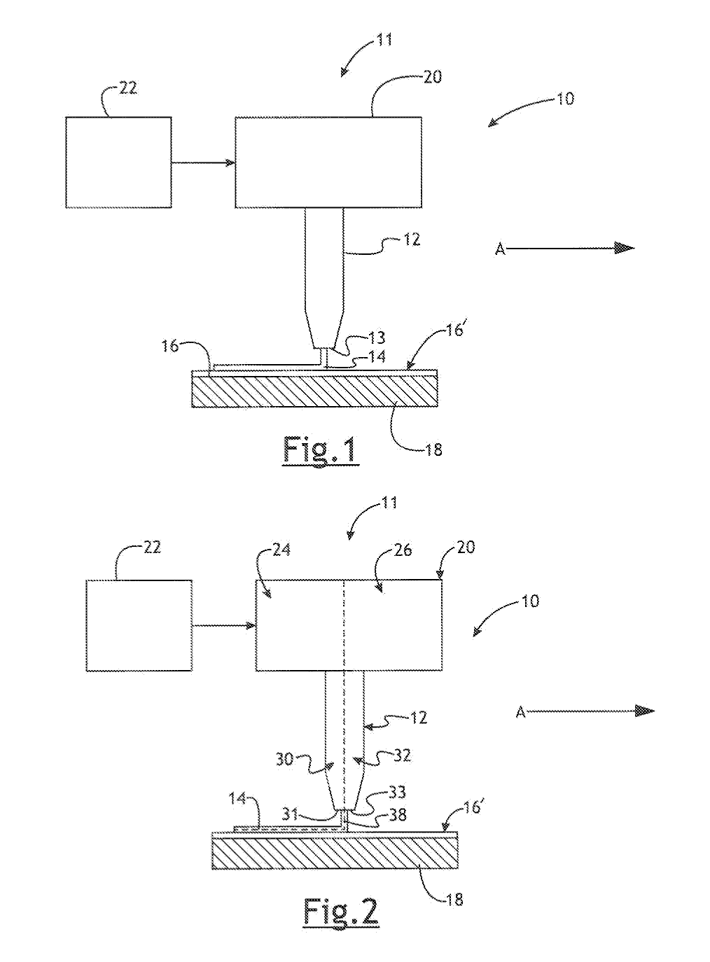

Referring now to FIG. 1, in one variation, the system 10 may include an applicator 11 which may have a first nozzle 12 having a through hole formed therein communicating with a first open end 13 of the nozzle. A composition including a bonding agent and a treatment composition or compound for treating or removing an undesirable layer 16′ on a surface 16 of a substrate 18. The first nozzle 12 may be operatively connected to a container 24 holding the composition. Alternatively, as will be appreciated from the description of other drawings and variations herein, the nozzle may be connected to an external storage tank including the composition and plumbed to deliver the composition to the nozzle 12. A controller 22 for controlling the movement and/or discharge of the composition from the applicator 11 may be provided and operatively connected to the applicator 11. In one variation, the substrate may be a metal including aluminum and the undesirable layer 16′ may be an oxide layer formed on the surface of the metal including aluminum. In another variation, the undesirable layer 16′ may be a surface treatment material which would adversely affect the adhesion of the bonding agent to the surface of the substrate 18 if not cleaned, removed or neutralized.

Referring now to FIG. 2, in another variation, a first nozzle 12 may be provided and may have a first through hole 30 communicating with an open end 31 of the nozzle 12 and a second through hole 32 communicating with the second open end 33 of the nozzle 12. The first through hole 30 may be in communication with a first chamber 24 provided in the container 20 and the second through hole 32 may be in communication with a second chamber 26 provided in the container 20. The applicator 11 may be moved along a surface of the substrate 18 in the direction of arrow A so that a composition 38 for treating the undesirable layer 16′ by neutralizing, cleaning or removing the undesirable layer 16′ is deposited directly on the undesirable layer 16′. The composition 38 for treating the substrate 18 may be dispensed from the second open end 33 of the nozzle. The bonding agent 14, such as, but not limited to, an adhesive, is dispensed from the first open end 31 of the nozzle and over the composition 38 for treating the substrate 18.

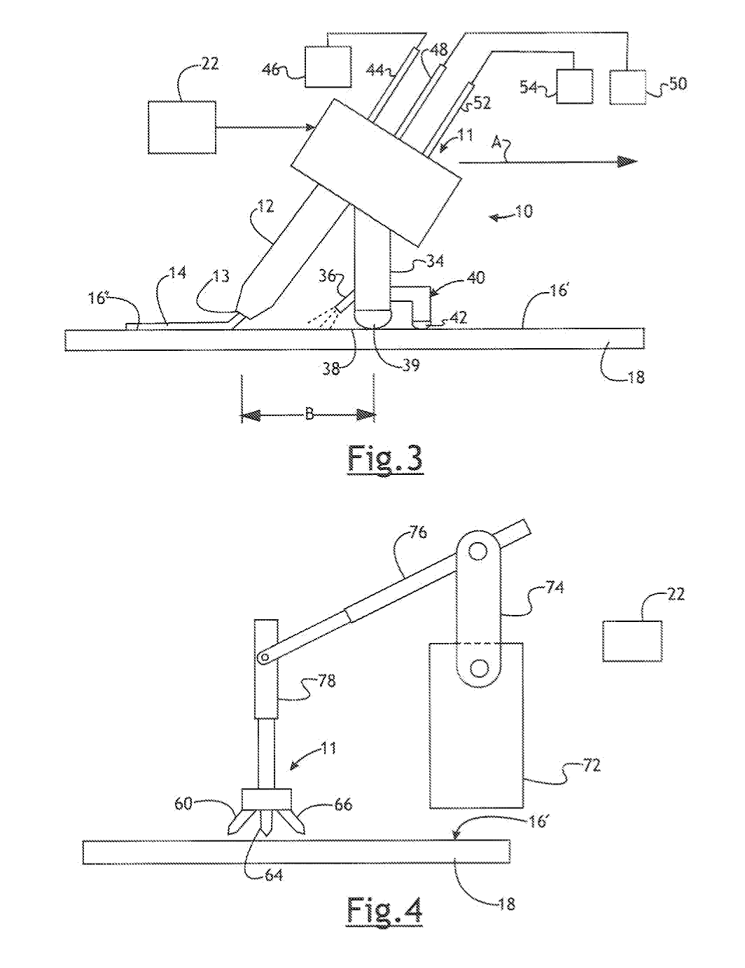

Referring now to FIG. 3, in another variation, the applicator 11 may include a first nozzle 12 having a first open end 13 for dispensing the bonding agent 14 onto a treated surface 16′ of the substrate 18. The applicator 11 is moved in a direction of arrow A along the surface of the substrate 18. The applicator 11 may also include a second nozzle 34 which may dispense the composition 38 for treating an undesirable layer 16′ on the surface of the substrate 18. In one variation, the second nozzle 34 may include a sponge or cloth-like material for wiping or swabbing the composition 38 onto the undesirable surface 16′ of the substrate 18. In another variation, a third nozzle 38 may be provided to discharge a gas such as air to assist in drying the composition 38 for treating the undesirable layer 16′ on the surface of the substrate 18. In another variation, in addition to or as an alternative to the use of a treatment composition 38, a mechanical treatment component 40 may be provided to mechanically remove an undesirable layer 16′ from the surface of the substrate. Mechanical treatment component may include, but not limited to, an abrading wheel, wire brush, tool or ultrasonic sander.

In select variations, a first line 44 may be connected to a first storage container 46 for delivering the bonding agent 14 to the first nozzle 12. A second line 48 may be provided and connected to a second storage container 50 for delivering a gas through the third nozzle 36 of the adapter 11. A third line 52 may be connected to a fourth storage container 54 for delivering the treatment composition 38 for treating the undesirable layer 16′ on the substrate 18.

In select embodiments, the distance B between the discharge point of the first applicator 12 and another applicator or mechanical treatment component is identified by the arrow labeled B. In select variations the distance B may range from a micrometer to less than 12 feet; from a micrometer to less than 6 feet; from a micrometer to less than 2 feet; from a micrometer to less than 1 foot; to a micrometer to less than 6 inches; to a micrometer to less than 2 inches; to a micrometer to less than 1 inch; from a micrometer to less than ½ inch; or less than ½ inch. The nozzles 12, 34 and/or mechanical component 40 or nozzle 36 may travel in unison and in a spaced apart relationship on or above a surface of the substrate.

Referring now to FIG. 4, in another variation, a controlled robot 72 having a plurality of arms 74, 76, 78 may be provided with an applicator 11 attached to the end of one of the arms. The applicator 11, in one variation, may include an adhesive applicator 60, a treatment composition applicator 66, and a gas applicator 64 for drying the treatment composition applied to the undesirable layer 16′ on the substrate 18. Alternatively, in place of or in addition to the treatment composition applicator 66, a mechanical treatment component 40 may be attached to the applicator 11 or may be controlled separately by another arm of the robot.

Referring now to FIG. 5, in another variation, a plurality of applicators may be individually connected to a cable 58 of a rail 56 to advance the applicators along a surface of the substrate 18 in the direction of arrow A. For example, in select variations, any combination of the following applicators may be provided on the rail system including an adhesive applicator 60, a heat applicator 62, a gas applicator 64, a treatment composition applicator 66, a CO₂ applicator 68 for mechanically removing the undesirable layer 16′ on the substrate 18, and/or a mechanical treatment applicator 70 for mechanically removing the undesirable layer 16′ on the substrate 18. At least a pair of the components 60, 62, 64, 66, 68, 70 may travel in unison and in a spaced apart relationship on or above a surface of the substrate.

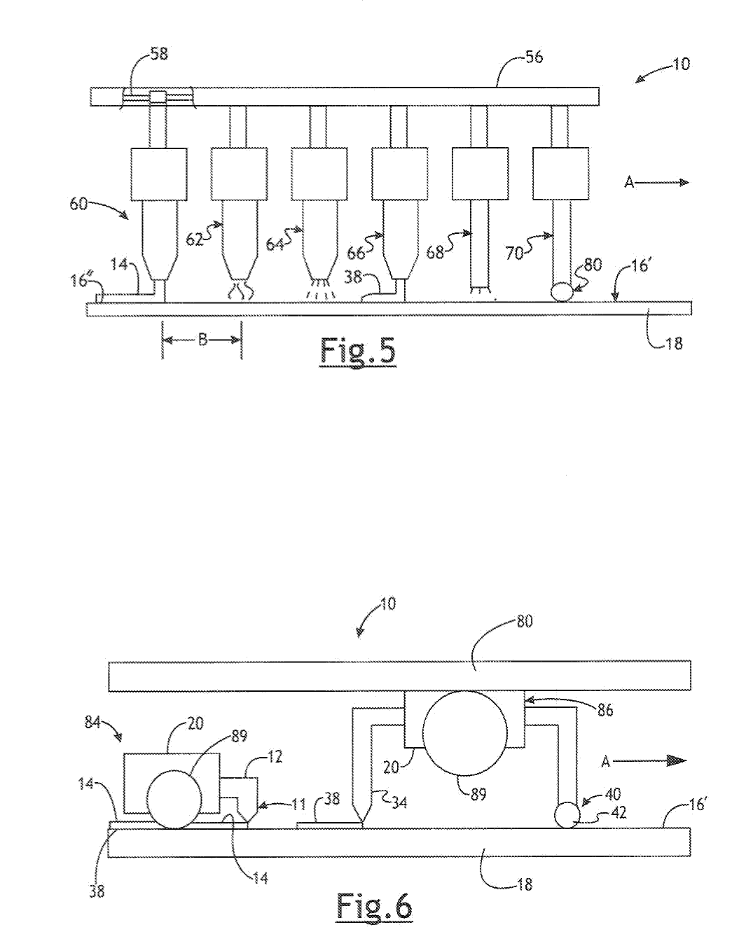

Referring now to FIG. 6, in another variation, at least a first remotely controlled device 84 may be provided and equipped with an applicator 11 including a first nozzle 12 for dispensing a composition for simultaneously treating a surface of the substrate and applying or adhering a bonding agent thereto as a single composition or separate compositions for the bonding agent and the surface treatment composition. Optionally, a second remotely controlled device 86 may be provided and may include a nozzle 34 for dispensing the treatment composition 38 and/or a mechanical component 40 including, for example, an abrasion wheel 42 (for mechanically removing the undesirable layer 16′ on the surface of the substrate 18). In one variation, the first remotely controlled device 84 and second remotely controlled device 86 may each include at least one wheel 89 for moving the device along the surface of the substrate 18 or along a suspended ceiling 80. For example, the second remotely controlled device 86 may be connected to the suspended ceiling 80 by any of a variety of means including, but not limited to, a magnetic force.

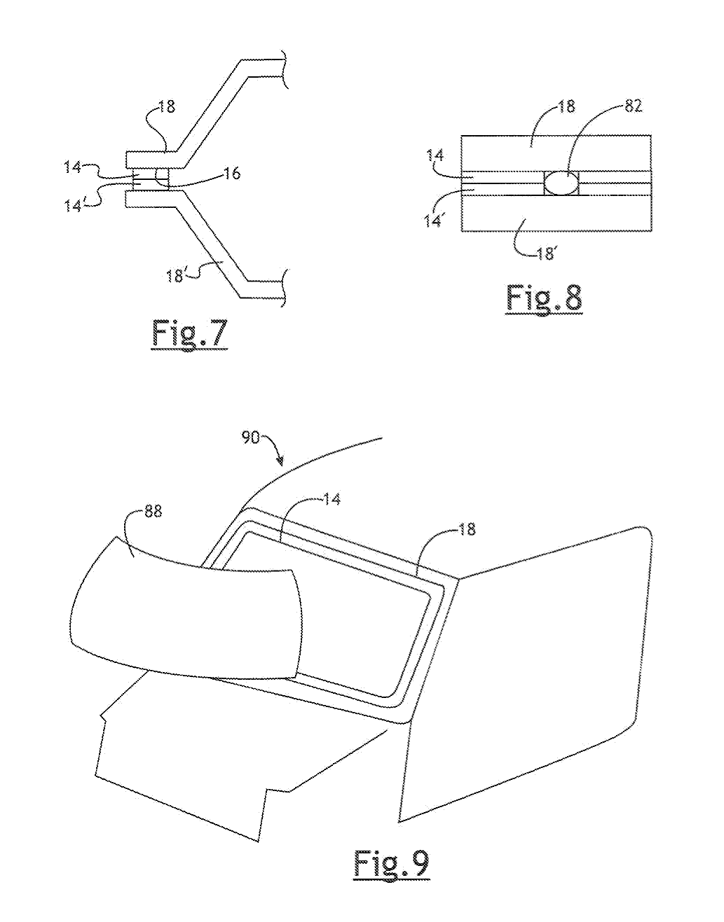

Referring now to FIG. 7, a plurality of substrates 18, 18′ may be connected together using a bonding agent 14, 14′ which has been applied to a surface 16 of the substrates which has been treated by a method of simultaneously treating the surface of the substrate and applying or adhering a bonding agent thereto. Such a method may be utilized to bond together a stamped panel for a vehicle to another stamped panel, cast component or extruded component. In addition to the adhesive 14 used to bond the substrate 18, 18′ together, the two substrates may be welded together for example as illustrated by the weld spot 82.

Referring now to FIG. 9, in another variation, a method of simultaneously treating a surface of the substrate and applying or adhering a bonding agent thereto may be utilized to attach a glass such as a windshield or rear window to a vehicle by treating the surface of a metal portion 18 of the vehicle and applying the adhesive 14 thereto. A windshield 88 may then be pressed against the adhesive 14 to secure the windshield to the body of the vehicle. Alternatively, a surface of the windshield may be simultaneously treated and a bonding agent applied or adhered thereto according to one variation of the invention.

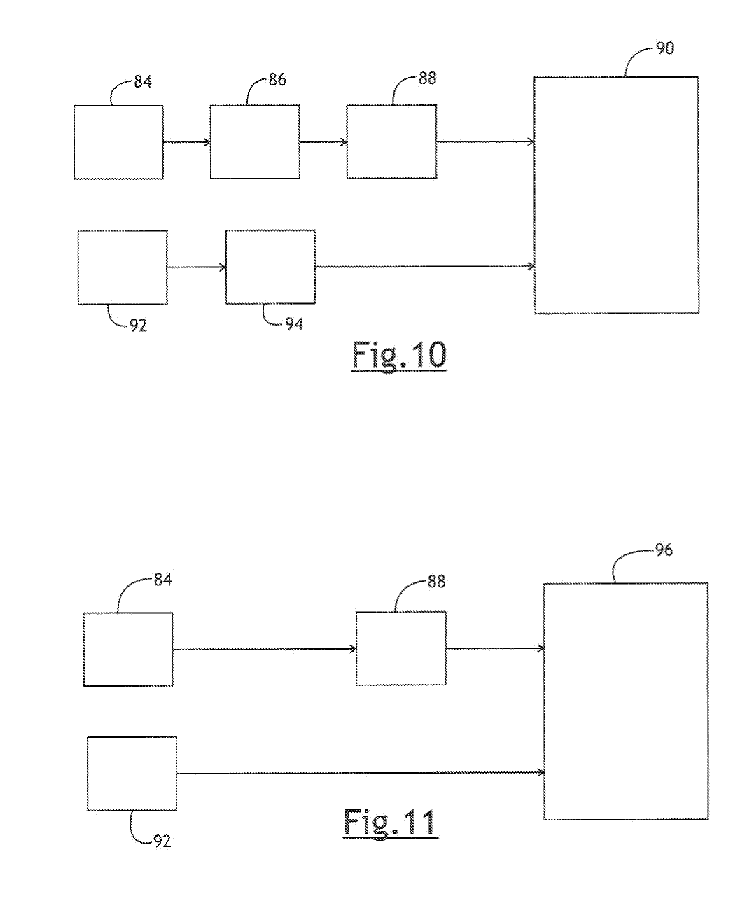

Referring now to FIG. 10, in the assembly of vehicle body components, an aluminum sheet may be provided in step 84 and the aluminum sheet may be pretreated in step 86 to passivate the aluminum sheet or to otherwise prepare the aluminum sheet for other processing steps. Thereafter, the pretreated aluminum sheet may be stamped in step 88 and thereafter an adhesive may be applied and the aluminum sheet having the adhesive thereon may be used to bond to another vehicle component in step 90. Aluminum castings or extrusions may also be provided in step 92 and the aluminum castings or extrusions may undergo a batch pretreatment in step 94. Thereafter, the aluminum castings or extrusions may have an adhesive layer applied thereto and may be utilized to bond to another vehicle component in step 90.

Referring now to FIG. 11, in select variations, a method may include providing a sheet including aluminum which has not been pretreated as shown in step 84. The aluminum sheet may be stamped as shown in step 88. Thereafter, a method of simultaneously treating a surface of the stamped sheet and applying or adhering a bonding agent thereto may be utilized as shown in step 96 to provide a sheet having a bonding agent thereon for bonding to another vehicle component. Castings or extrusions including aluminum may also be provided as shown in step 92. The aluminum castings or extrusions have not been pretreated. The castings or extrusions including aluminum may then be subjected to a method including simultaneously treating a surface of the casting or extrusion and applying or adhering a bonding agent thereto according to one variation. The sheet including aluminum and/or the castings or extrusions including aluminum may be bonded together or may be bonded to other material such as stainless steel to form a portion of a vehicle. As such, a method of simultaneously treating a surface and applying or adhering a bonding agent thereto may be used in the manufacturing of vehicle components in a plant utilizing sheets including aluminum and/or castings or extrusions including aluminum without the need for pretreating the aluminum sheet or batch pretreating the aluminum castings or extrusions.

In one variation, a suitable bonding agent may include an epoxy based adhesive and a suitable surface treatment composition may include phosphoric acid. The surface preparation can include alkaline degreasing, acid etching, titanium or titanium/zirconium passivation. Laser cleaning may also be used to pre-treat the surface of the substrate such as aluminum. In select variations, the adhesive may be 1 part heat curable or 2 part room temperature curable adhesives.

When the terms “over”, “overlying”, “overlies”, or “under”, “underlying”, “underlies” are used with respect to the relative position of a first component or layer with respect to a second component or layer, such shall mean that the first component or layer is in direct contact with the second component or layer, or that additional layers or components are interposed between the first component or layer and the second component or layer.

The above description of variations of the invention is merely illustrative in nature and, thus, variations thereof are not to be regarded as a departure from the spirit and scope of the invention.

1. A method comprising simultaneously treating a substrate having an undesirable layer on a surface of the substrate and adhering or apply a bonding agent to the substrate using a signal applicator or multiple applicators traveling in unison on or above a surface of the substrate.

2. A method as set forth in claim 1 wherein the substrate comprises aluminum and wherein the undesirable layer comprises an oxide layer.

3. A method as set forth in claim 1 wherein the bonding agent comprises an epoxy based adhesive.

4. A method as set forth in claim 1 wherein the treating a substrate having an undesirable layer on a surface of the substrate comprises depositing a composition on the undesirable layer.

5. A method as set forth in claim 1 wherein simultaneously treating a substrate having an undesirable layer on a surface of the substrate and adhering or apply a bonding agent to the substrate comprises depositing a composition including a bonding agent and a composition to treat the undesirable layer from a single applicator.

6. A method as set forth in claim 1 wherein the treating comprises depositing a composition on the undesirable layer to improve the adhesion of the bonding agent to the substrate.

7. A method as set forth in claim 1 wherein the treating comprises depositing a composition for treating the undesirable layer on the undesirable layer and depositing a bonding agent over the composition.

8. A method as set forth in claim 1 wherein the treating comprises at least one of mechanical removal of an undesirable layer or chemical treating of the undesirable layer.

9. A method as set forth in claim 1 further comprising using a robot having at least one applicator attached to an arm thereof.

10. A method as set forth in claim 1 using multiple applicators including at least a bonding agent applicator connected to a rail, and a treatment composition applicator or a mechanical treatment applicator also connected to the rail, the applicators being in a spaced apart relationship.

11. A method as set forth in claim 1 further comprising utilizing remotely controlled carriers having a bonding agent applicator and a chemical treatment applicator and/or mechanical treatment applicator.

12. A method as set forth in claim 1 wherein the substrate comprises a stamped metal comprising aluminum.

13. A method as set forth in claim 1 wherein the substrate comprises a cast or extruded metal comprising aluminum.

14. A method as set forth in claim 1 wherein the substrate comprises glass.

15. A method as set forth in claim 1 wherein the substrate comprises a front windshield or rear windshield for a vehicle.

16. A method providing a sheet of metal comprising aluminum which has not been pretreated to passivate the surface, stamping the sheet comprising aluminum and thereafter simultaneously treating the sheet comprising aluminum to remove any oxide along a portion of the sheet and adhering or applying a bonding agent to the sheet along the portion that has been treated to removed the oxide therefrom.

17. A method as set forth in claim 16 further comprising simultaneously treating the casting or extrusion to remove an oxide layer thereon and adhering or applying a bonding agent thereto, and pressing the aluminum sheet and the casting or extrusion together to adhere the same.

18. A method as set forth in claim set forth in claim 16 further comprising bonding a stamped sheet of stainless steel to the sheet of metal comprising aluminum.

19. A method comprising providing a casting or extrusion comprising aluminum which has not been pretreated to remove an oxide layer thereon and simultaneously treating the casting or extrusion to remove an oxide layer along a portion thereof and adhering or applying a bonding agent to the portion having the oxide layer removed therefrom.

20. A method as set forth in claim set forth in claim 19 further comprising bonding a stamped sheet of stainless steel to the casting or extrusion comprising aluminum.
